(19) United States
(12) Patent Application Publication
(10) Pub. No.: US 2025/0190803 A1
(43) Pub. Date: Jun. 12, 2025

(54) SMART ANNOTATION FOR RECORDED WAVEFORMS REPRESENTING PHYSIOLOGICAL CHARACTERISTICS

(71) Applicant: DRAGERWERK AG & CO. KGAA, LUBECK (DE)

(72) Inventors: Anne-severine Lima PIMENTA, Windham, NH (US); Xianju WANG, Bedford, MA (US)

(21) Appl. No.: 18/845,356

(22) PCT Filed: Jun. 21, 2023
(86) PCT No.: PCT/IB2023/056432

§ 371 Date: Sep. 9, 2024

Related U.S. Application Data
(60) Provisional application No. 63/354,541, filed on Jun. 22, 2022.

(51) Int. Cl. G06N 3/0895; G06N 3/0455; G06N 3/088

(52) U.S. Cl. CPC G06N 3/0895; G06N 3/0455; G06N 3/088

(57) ABSTRACT

In some embodiments, a method includes training an autoencoder with a set of unlabeled input samples through unsupervised learning and training a deep neural network through supervised learning using the trained autoencoder. The unlabeled input samples may be recorded waveforms representing a physiological characteristic of a human body. Training the deep neural network through supervised learning using the trained autoencoder may include: training the deep neural network with a first subset of manually labeled samples selected from the set of unlabeled samples; and iteratively training the deep neural network with a plurality of successive subsets of manually labeled samples drawn from the unlabeled samples until convergence or until the unlabeled sample inputs are exhausted. Each successive subset includes a plurality of selected, distanced unlabeled samples with the least confidence from the remaining unlabeled samples to which labels are propagated, the distance determination including using the autoencoder for feature extraction.

### CROSS-REFERENCE TO RELATED APPLICATIONS

The priority and earlier effective filing date of U.S. Application Ser. No. 63/354,541, filed Jun. 22, 2022, is hereby claimed for all purposes, including the right of priority. This related application is also hereby incorporated by reference for all purposes as if expressly set forth verbatim herein.

### TECHNICAL FIELD

The present disclosure pertains deep neural networks for classifying recorded waveforms representing a physiological characteristic of a human body and, more particularly a technique for training such a deep neural network.

### DESCRIPTION OF THE RELATED ART

This section of this document introduces information about and/or from the art that may provide context for or be related to the subject matter described herein and/or claimed below. It provides background information to facilitate a better understanding of the various aspects of the that which is claimed below. This is a discussion of “related” art. That such art is related in no way implies that it is also “prior” art. The related art may or may not be prior art. The discussion in this section of this document is to be read in this light, and not as admissions of prior art.

The physiological state of a patient in a clinical setting is frequently represented by monitoring one or more physiological characteristics of the patient over time. The monitoring usually includes capturing data using sensors, the captured data representing the physiological characteristic. Because the data is representative of a physiological characteristic, the data may be referred to as “physiological data”.

In one common example known as electrocardiography, a number of electrodes are placed at predetermined points on the patient's body. Each sensor produces a voltage signal that is captured and graphed. The graph, or electrocardiogram (“ECG”, or “EKG”), provides a visual representation of the magnitude of the voltage signal over time. A trained clinician or technician can then determine how “normally” or “non-normally” the patient's heart is beating. Thus, in this context, the captured physiological data is representative of the patient's heartbeat.

The data captured by such monitoring is typically ordered by at least the time of acquisition and an attribute of the physiological characteristic as represented in the data. In the ECG example above, the data is ordered not only by time of acquisition and the magnitude of the voltage, but also by the sensor through which the data was acquired. The voltage acquired by an individual sensor can be rendering it for human perception as a graph, or plot, of the voltage magnitude over time referred to as a “waveform”. It is also common to collectively refer to the physiological data as a “waveform”. The result of the ECG, then, is a set of waveforms reflecting the patient's heartbeat.

It was mentioned above relative to the ECG that a trained clinician or technician may analyze “waveforms” to determine certain aspects of the patient's condition captured in the physiological data. For a variety of reasons, the art has turned to “intelligent machines”, or computing machines employing various kinds of artificial intelligences, to perform this analysis or evaluation. However, like the clinician or technician, the intelligent machine is trained to perform this analysis.

### SUMMARY

In some embodiments, a method comprises training an autoencoder with a set of unlabeled input samples through unsupervised learning and training a deep neural network through supervised learning using the trained autoencoder. The unlabeled input samples may be recorded waveforms representing a physiological characteristic of a human body. Training the deep neural network through supervised learning using the trained autoencoder, includes: training the deep neural network with a first subset of manually labeled samples selected from the set of unlabeled samples; and iteratively training the deep neural network with a plurality of successive subsets of manually labeled samples drawn from the unlabeled samples until convergence or until the unlabeled sample inputs are exhausted. Each successive subset comprises a plurality of selected, distanced, unlabeled samples with the least confidence from the remaining unlabeled samples to which labels are propagated, the distance determination including using the autoencoder for feature extraction.

In other embodiments, a method, comprises: training an autoencoder with a plurality of unlabeled input samples through unsupervised learning and training a deep neural network through supervised learning using the trained autoencoder. The unlabeled input samples being recorded waveforms representing a physiological characteristic of a human body. Training a deep neural network through supervised learning using the trained autoencoder, includes: manually labeling a first predetermined number of randomly selected unlabeled samples from the plurality of unlabeled input samples to generate a first subset of labeled samples; training the deep neural network with the first subset of labeled samples, manually labeling a second predetermined number of selected, distanced, unlabeled samples to generate a second subset of labeled samples, propagating labels to the second predetermined number of selected, distanced, unlabeled samples from among the remaining unlabeled samples that are closest to the labeled samples; and iterating until either convergence or the remaining unlabeled samples are exhausted. Manually labeling a second predetermined number of selected, distanced, unlabeled samples to generate a second subset of labeled samples may include: selecting a plurality of unlabeled samples with the least confidence from the remaining unlabeled samples; and filtering the selected plurality of unlabeled samples to discard selected unlabeled samples that are too close to another selected unlabeled sample using the trained autoencoder for feature extraction of the compared selected unlabeled sample.

In still other embodiments, there is a method for use in annotating a plurality of recorded waveforms representing a physiological characteristic of a human body. The method comprises: providing a set of unlabeled samples of the recorded waveforms; training a deep neural network with the unlabeled samples to develop an autoencoder; receiving a plurality of manual labels for a first predetermined number of randomly selected, unlabeled samples; augmenting the manually labeled, randomly selected samples; training a deep neural network with the augmented, manually labeled, randomly selected samples; applying the trained deep neural network to the remaining unlabeled samples; receiving a second predetermined number of selections of the remaining unlabeled sample; propagating labels to a third predetermined number of the remaining unlabeled samples that were closest to the labeled samples; and iterating until either convergence or the remaining unlabeled samples are exhausted. In these embodiments, receiving the second predetermined number of selections of the remaining unlabeled samples, the selection includes: identifying the second predetermined number of candidate unlabeled samples having the least confidence; and filtering the identified candidate unlabeled. The filtering then includes using the trained autoencoder for feature extraction to determine whether each identified candidate is too close to an immediately prior identified candidate; if an identified candidate is too close to the immediately prior identified candidate, discarding the identified candidate; identifying a replacement candidate for the discarded candidate; and iterating the identifying and filtering until the second predetermined number of unlabeled samples has been identified and filtered;

In still other embodiments, a computing apparatus, comprises: a processor-based resource; and a memory electronically communicating with the processor-based resource. The memory may be encoded with instructions that, when executed by the processor-based resource, perform the methods set forth herein.

Still other embodiments include a non-transitory, computer-readable memory encoded with instructions that, when executed by a processor-based resource, perform the methods set forth herein.

### BRIEF DESCRIPTION OF THE DRAWINGS

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

FIGS. 1A-1B depict normal beats from a set of acquired ECG waveforms as may be used as sample inputs in some embodiments of the technique disclosed herein.

FIGS. 2A-2C depict non-normal beats from a set of acquired ECG waveforms as may be used as sample inputs in some embodiments of the technique disclosed herein.

FIG. 3 illustrates an ECG procedure by which sample inputs, such as the beats of FIGS. 1A-1B and 2A-2C may be acquired in some embodiments.

FIG. 4 depicts an ECG waveform such as might be acquired in the ECG procedure of FIG. 3 and processed to receive sample inputs, such as the beats of FIGS. 1A-1B and 2A-2C.

FIG. 5 conceptually illustrates one particular embodiment of a computing apparatus with which various aspects of the disclosed technique may be practiced in accordance with one or more embodiments.

FIG. 6A-FIG. 6B depict one particular embodiment of an autoencoder as may be used in some embodiments of the presently claimed subject matter.

FIG. 6C depicts a deep neural network and, more specifically, a convolutional neural network, as may be used in some embodiments of the presently claimed subject matter.

FIG. 7 illustrates a method as may be practiced in accordance with one or more embodiments.

FIG. 9A-FIG. 9C is a flow chart of one particular computer-implemented implementation of one or more embodiments.

FIG. 9A-FIG. 9C is a flow chart of one particular computer-implemented implementation of one or more embodiments.

FIG. 10 illustrates the efficacy of the technique disclosed herein.

FIG. 11A-FIG. 11D graphically illustrates the presently disclosed technique in one or more embodiments.

While the invention is susceptible to various modifications and alternative forms, the drawings illustrate specific examples herein described in detail by way of example. It should be understood, however, that the description herein of specific examples is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Machine learning and deep learning is a very powerful mathematic tool to solve classification and regression problems. Supervised learning and unsupervised learning are two major methods.

Supervised learning makes predictions based on a set of labeled training examples that users provide. This technique is useful when one knows what the outcome should look like. Supervised learning is usually used to predict future outcome (regression problem) or classify the input data (classification problem). In supervised learning, one generates annotations/labels for training samples, then train the model with these training samples, then test and deploy your model to your system.

In unsupervised learning, the data points are not labeled—the algorithm labels them itself by organizing the data or describing its structure. This technique is useful when it is not known what the outcome should look like, and one is trying to find hidden structure inside data sets. For example, one might provide customer data, and want to create segments of customers who like similar products. The data that is provided isn't labeled, and the labels in the outcome are generated based on the similarities that were discovered between input data.

One drawback to supervised learning is that labeling, or annotating, the input samples may be arduous and time consuming. Labeling a group of input samples generally involves a knowledgeable and trained person examining each input sample, determining a “correct” outcome for each input sample, and then annotating each input sample with that respective correct outcome. The number of input samples may also be large. These kinds of factors, when present, cumulatively assure that annotating the input samples is a long and difficult task.

This disclosure presents a technique including a method and an apparatus for supervised training of a neural network that greatly reduces the time, cost, and effort for annotating the training set and training a deep neural network. This technique can be referred to as a “smart annotation” technique because it engenders these savings in resources. As used herein, a smart annotation technique is one that uses, for example, an autoencoder trained via unsupervised learning and applies both supervised and unsupervised learning to train a neural network. The supervised learning includes least confidence assessment combined with label propagation and an autoencoder to train the neural network. The technique includes not only such a method, but also a computing apparatus programmed to perform such a method by executing instructions stored on a computer-readable, non-transitory storage medium using a processor-based resource.

The technique as disclosed herein presumes that a set of input samples has previously been acquired. The input samples in the disclosed embodiments are ECG waveforms. However, it is to be understood that this is for illustration only, and that embodiments may also operate on input samples of waveforms acquired using other processes. For example, it is common in patient care to monitor a number of physiological characteristics of a patient that can be acquired using other procedures and represented as a waveform. The technique described herein may be used in conjunction with such other waveforms acquired by other procedures and representative of other physiological characteristics. Examples of such other physiological characteristics include, but are not limited to invasive pressures (i.e. invasive blood pressure), gas output from respiration (i.e. oxygen, carbon dioxide), blood oxygenation, internal pressures (i.e. intracranial pressures), measurement of concentration of anesthesia agents (i.e. nitrous oxide), etc.

Furthermore, the input samples disclosed herein are “organic” in the sense that they have been acquired by actually perform ECG procedures on patient(s). The input samples in other embodiments may be synthetic in the sense that they have been acquired by artificially generating them. Still other embodiments may use a combination of organic and synthetic waveforms.

ECG waveforms are acquired over time and represent a number of heartbeats occurring within a predetermined window of time. These waveforms may be sampled as portions of the larger ECG waveform, each portion representing a single heartbeat. The ECG waveforms in the input samples of the illustrated embodiment may therefore be referred to as “beats” because they are portions of a larger waveform representing a single heartbeat. Thus, the input samples for the disclosed technique may be obtained by sampling portions of larger waveforms.

This particular embodiment will classify input samples (or, “beats”) as either “normal” or “non-normal”—that is, whether the heartbeat they represent is normal or non-normal. For example, in the illustrated embodiment where the input samples are beats, a beat showing an atrial fibrillation (or, “afib”) would be classified as non-normal. Using the terminology above, each outcome of the evaluation process will be either “normal” or “non-normal”. The terms “normal” and “non-normal” are clinically defined and those definitions are well known to those skilled in the art of evaluating ECG waveforms.

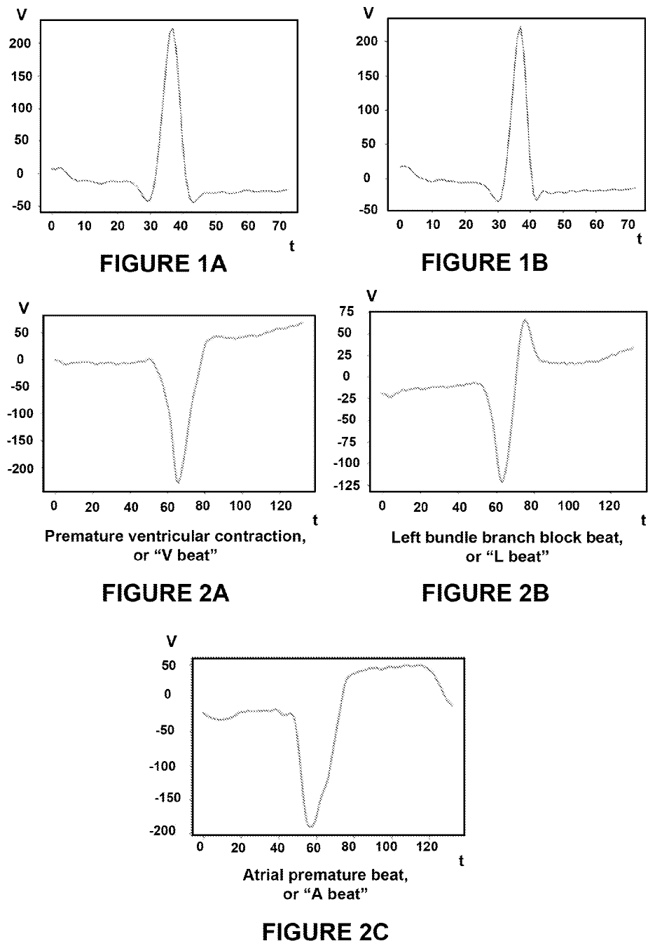

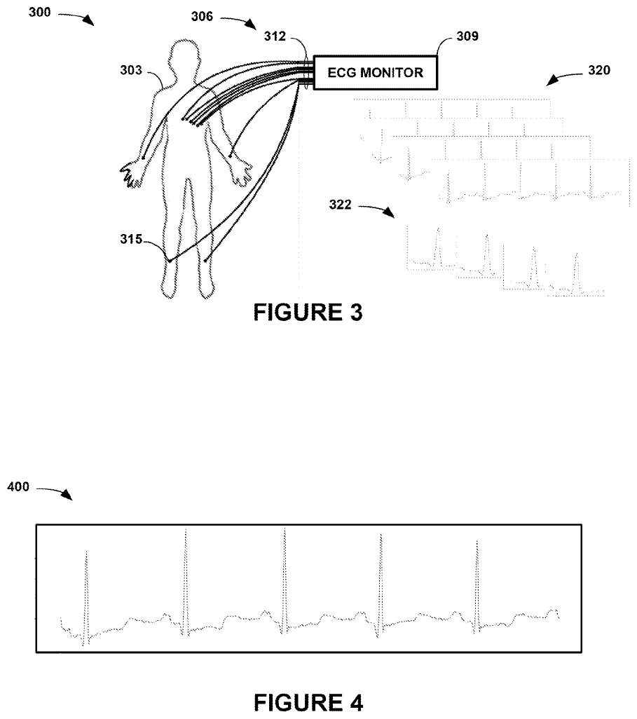

For example, for ECG beat classification, each training sample includes one beat as shown in FIG. 1A-FIG. 2C (around 75 sample points). One needs to label/annotate each beat as “labeled”, or “annotated”, if it is a normal or non-normal beat. The samples are usually randomly selected for annotation. To reach 95.1% classification accuracy in ECG beat classification, one needs around 3080 training samples using conventional approaches. This will be a big effort to complete, as one needs to go through these samples one by one to annotate them. The presently disclosed approach reduces the number of annotated samples to reach the same accuracy. With the presently disclosed technique, one only needs to annotate around 952 training samples to reach the same accuracy. So, the annotation effort is reduced about three times.

In the illustrated embodiment, ECG beats are classified to two classes, as mentioned above. One class is normal beat, the other is non-normal beat, which includes: Left bundle branch block, Right bundle branch block, Bundle branch block, Atrial premature, Premature ventricular contraction, Supraventricular premature or ectopic beat (atrial or nodal), Ventricular escape. Some examples are shown in FIG. 2A-FIG. 2C: Atrial fibrillation is an irregular and often rapid heart rate that can increase your risk of strokes, heart failure and other heart-related complications. We applied 1D Convolutional Neural Network and get very good performance to classify Afib beat and normal beat. Atrial fibrillation is an irregular and often rapid heart rate that can increase your risk of strokes, heart failure and other heart-related complications. The illustrated embodiments apply a 1D Convolutional Neural Network and get very good performance to classify Afib beat and normal beat

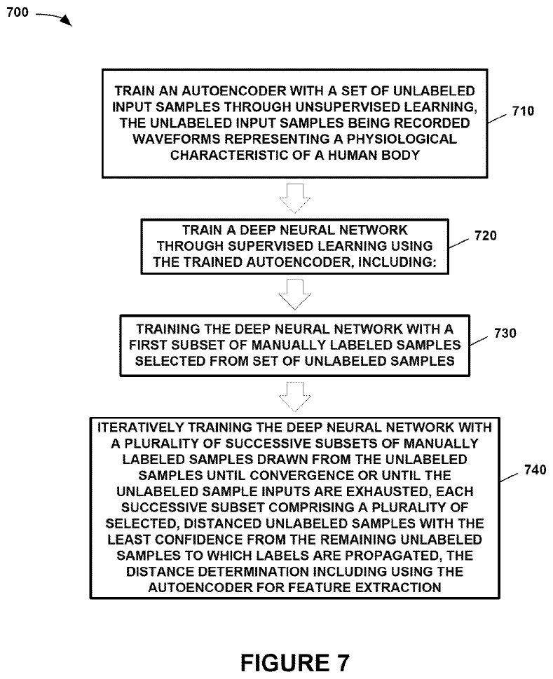

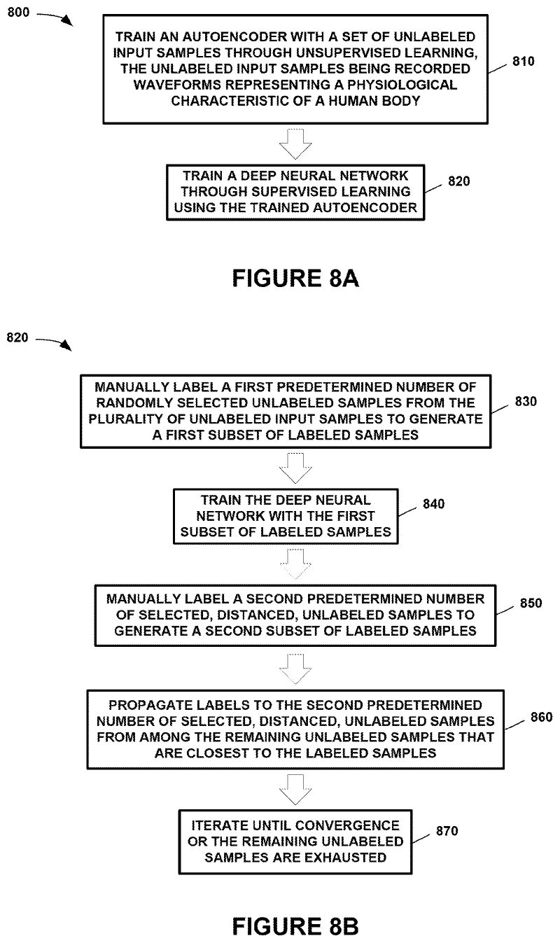

The disclosed technique uses unsupervised learning to build an autoencoder by training with unlabeled data. An autoencoder is a type of neural network that can be used to learn a compressed representation of raw data. An autoencoder is composed of an encoder and a decoder sub-model. The encoder compresses the input and the decoder attempts to recreate the input from the compressed version provided by the encoder. After training, the encoder model is saved, and the decoder is discarded. One suitable autoencoder and its use for feature extraction are described further below relative to FIG. 6A-FIG. 6B.

N samples are then randomly picked and are labeled by hand. In one embodiment, N=56, for example. The labelled samples are then trained with a deep neural network with data augmentation (noise with small variance). The data augmentation reduces overfitting during training. The present technique then runs a trained deep neural network on remaining unlabeled samples, use the least confidence to pick N samples that are then labeled by hand. This is a general method used in active learning, but the presently disclosed technique modifies the conventional approaches. In particular, if two new samples are close enough (using trained Autoencoder to extract the features and the feature distance between samples is used to represent sample distance), the present technique will ignore the second one and keep looking for the next least confidence sample.

Next, label propagation is applied for N samples. Within unlabeled samples, N samples closest to labeled samples are identified and added for training. But each labeled sample only propagates one sample. So, each iteration, there are 2N new training samples. N samples from user annotation and N samples are from automatic label propagation. The present approach then returns to train labeled samples with the deep neural network and iterates until the accuracy changes less than 0.25% in five iterations.

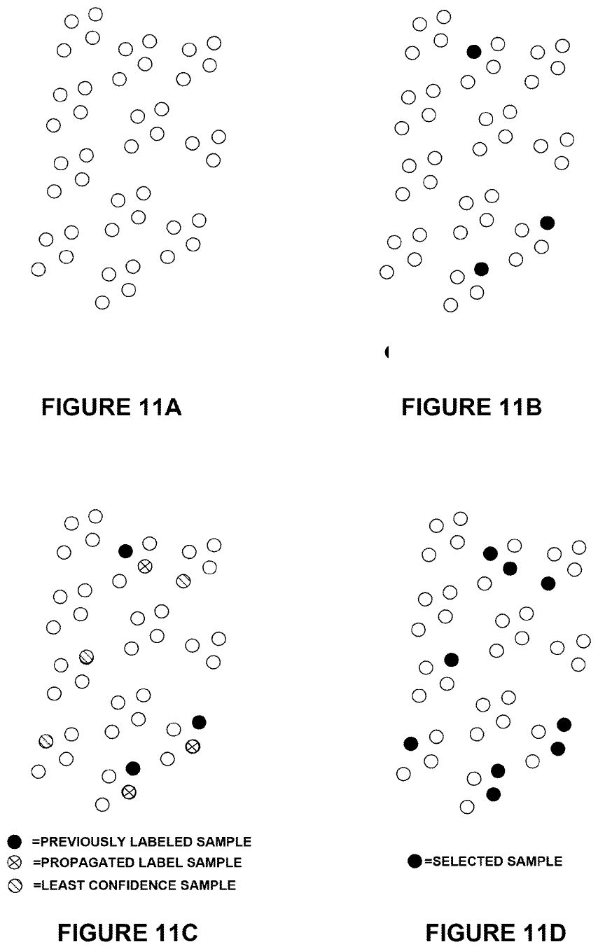

The presently disclosed technique may also be illustrated graphically as shown in FIG. 11A-FIG. 11D. FIG. 11A conceptually illustrates a feature space in which the samples, represented by circles, are present. As shown in FIG. 11B, N samples are selected and hand-labeled. In this example, N=3 for ease of illustration. The deep neural network is then trained and the labels propagated as described above. The three previously labeled samples, three samples with propagated labels, and three previously unlabeled samples with least confidence are identified as shown in FIG. 11C and selected as shown in FIG. 11D. The deep neural network is then retrained using the new sample set of FIG. 11D. These last two steps of retraining and then selecting least confidence and propagated label samples is iterated until convergence.

More particularly, FIGS. 1A-1B depict normal beats and FIGS. 2A-2C depict non-normal beats, the beats having been rendered for human perception. One criterion in the selection of the input sample set is that it contains a statistically significant number of each potential outcome. In the illustrated embodiment, there should therefore be a statistically significant number of both “normal” and “non-normal” beats. Note that, as discussed above, the beats are waveforms that are actually sets of ordered data.

Note, however, that other embodiments may be used to analyze and/or classify input samples representing some other physiological characteristic. Examples of such other physiological characteristics include, but are not limited to, invasive pressures (e.g., invasive blood pressure), gas output from respiration (e.g., oxygen, carbon dioxide), blood oxygenation, internal pressures (e.g., intracranial pressures), measurement of concentration of anesthesia agents (e.g., nitrous oxide), etc. The classification of the input samples may therefore vary in some embodiments to accommodate aspects of the physiological characteristic of interest to a clinician. The number of classifications might also vary from two to three or more. For example, in some embodiments, rather that classifying the input samples as “normal” or “non-normal”, a sample might be classified as “high”, “normal”, or “low”. Still other physiological characteristics and classifications may become apparent to those skilled in the art having the benefit of this disclosure.

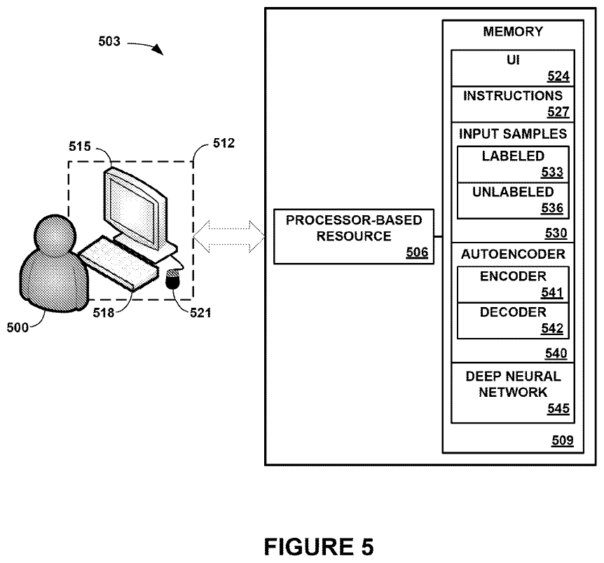

Although the technique as disclosed presumes the input samples will previously have been acquired, acquisition of input samples in an ECG context will now be discussed for the sake of completeness. FIG. 3 illustrates an ECG procedure 300 in accordance with the present disclosure. In FIG. 3, a patient 303 is undergoing the ECG procedure 300 being administered using the ECG system 306. The ECG system 306 comprises an ECG monitor 309, a plurality of electrical leads 312, and a plurality of ECG electrodes 315 (only one indicated). There need not be a 1:1 correspondence between the ECG electrodes 315 and the electrical leads 312 as is shown in FIG. 3. One common configuration, and one with which the currently disclosed technique may be practiced, is a 10 electrode, 12 lead configuration to measure 10 voltages across a person's body.

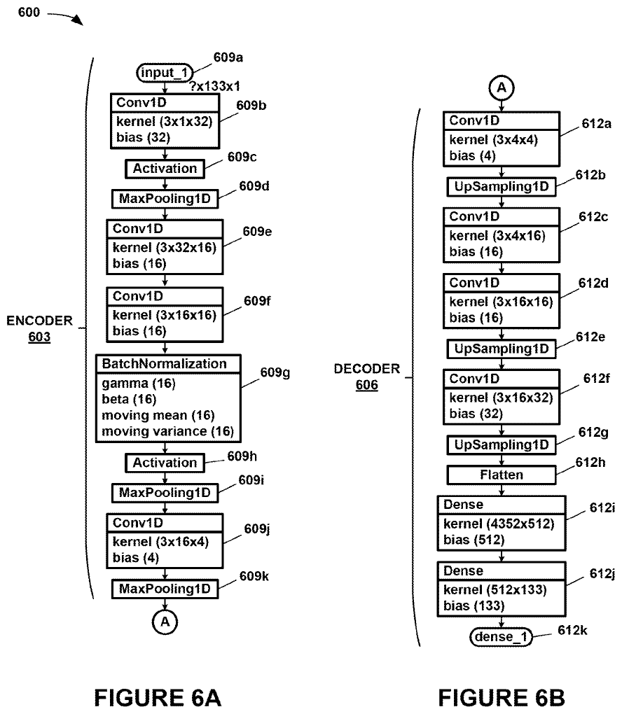

The ECG system 306 acquires a number of ECG waveforms 320 such as the example waveform 400 in FIG. 4. The ECG waveforms 320 are then processed to generate the individual input samples, or beats, 322. The processing may be performed by the ECG monitor 309. However, more likely, the ECG waveforms 320 will be exported to another computing apparatus or computing system (not shown) where the processing is performed.

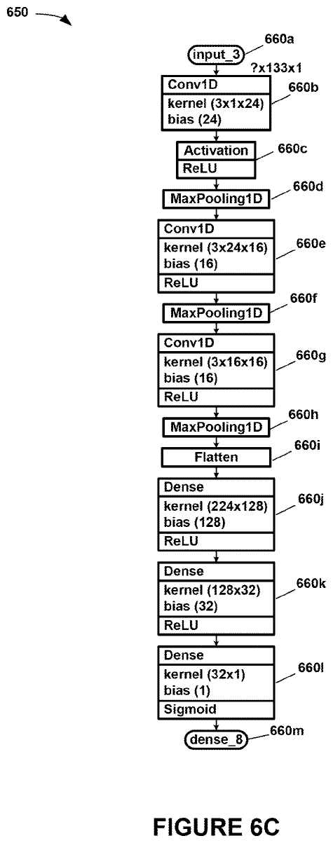

The processing may be performed manually on, for example, a workstation, by a user through a user interface. So, for example, in the embodiment of FIG. 5, discussed further below, a user 500 may manually process one or more ECG waveforms through the user interface 512 of the computing apparatus 503. In other embodiments the processing may be performed automatically by a neural network (not shown) trained for beat detection in an ECG waveform. Again, the ECG waveforms 320 and the input samples 322 are shown rendered for human perception in FIG. 3.

FIG. 5 illustrates a user 500 at a computing apparatus 503 with which certain computer-implemented aspects of the disclosed technique may be performed. The user 500 may be, depending on the task being performed and the skills involved, a person trained and skilled at classifying the input samples. For example, in embodiments such as the one disclosure herein in which the input samples are beats, the user 500 may be clinician or technician who can classify and label input samples as normal or non-normal. Or, for the more computationally skilled aspects of the disclosed technique, the user 500 may be a person such as a software engineer. Or the user 500 may be a person suitably skilled to perform both the label and classify and the computationally oriented tasks.

The computing apparatus 503 may be, for instance, a workstation. The computing apparatus 503 includes, in this embodiment, a processor-based resource 506, a memory 509, and a user interface 512. The user interface 512 includes a display 515, one or more peripheral devices such as a keyboard 518 and/or mouse 521, and a software component (“UI”) 524 residing on the memory 509. The UI software component 524 is executed by the processor-based resource 506 to provide a presentation (not separately shown) on the display 515 with which the user 500 may interact using the peripheral component(s).

As those in the art having the benefit of this disclosure will appreciate, the term “processor” is understood in the art to have a definite connotation of structure. A processor may be hardware, software, or some combination of the two. In the illustrated embodiment of FIG. 5, the processor-based resource 506 is a programmed hardware processor, such as a controller, a microcontroller or a Central Processing Unit (“CPU”). However, in alternative embodiments, the processor-based resource 506 may be a Digital Signal Processor (“DSP”), a graphics processor, a processor chip set, an Application Specific Integrated Circuit (“ASIC”), an appropriately programmed Electrically Programmable Read-Only Memory (“EPROM”), an appropriately programmed Electrically Erasable, Programmable Read-Only Memory (“EEPROM”), or any other equivalent integrated or discrete logic circuitry, as well as any combinations of such components and one or more machine learning algorithms.

The processor-based resource 506 executes machine executable instructions 527 residing in the memory 509 to perform the functionality of the technique described herein. The instructions 527 may be embedded as firmware in the memory 509 or encoded as routines, subroutines, applications, etc. The memory 509 is a computer-readable non-transitory storage medium and may be local or remote. The memory 509 may be distributed, for example, across a computing cloud. The memory 509 may include Read-Only Memory (“ROM”), Random Access Memory (“RAM”), or a combination of the two. The memory 509 will typically be installed memory but may be removable. The memory 509 may be primary storage, secondary, tertiary storage, or some combination thereof implemented using electromagnetic, optical, or solid-state technologies. Accordingly, the memory 509 may be in various embodiments, a part of a mass storage device, a hard disk drive, a solid-state drive, an external drive (whether disk or solid-state), an optical disk, a magnetic disk, a portable external drive, a jump drive, etc.

Accordingly, in the illustrated embodiment, the computing apparatus 503 performs the computer-implemented functionality of the presently disclosed technique. More particularly, the processor-based resource 506 executes the instructions 527, both shown in FIG. 5, to perform the programmed functionality of the disclosed smart annotation technique disclosed herein. However, the presently claimed subject matter is not so limited.

For example, in some embodiments the computing apparatus 503 may be some other kind of personal computing apparatus and may access data over a network such as a Local Area Network (“LAN”). In other embodiments, the computing apparatus 503 may be a computing system. In such a computing system, the processing and memory resources may be distributed across a cloud, for example, accessed from a workstation or other personal computing device over a public or private network such as the Internet. Still other variations in the computing apparatus 503 may be realized by those skilled in the art having the benefit of this disclosure.

Still referring to FIG. 5, a residing in the memory 509 is a set of input samples 530. The input samples 530 may comprise labeled samples 533 and unlabeled samples 536. For present purposes, “manually labeled” means labeled by a person such as the user 500 on a computing apparatus such as the computing apparatus 503 through a user interface such as the user interface 512. As will be discussed further below, at the beginning of the smart annotation technique disclosed herein, all the input samples 530 are unlabeled samples 536. The technique includes labeling some of the unlabeled samples 536 such that the number of labeled samples 533 grows as the acts comprising the technique are performed.

Also residing in the memory 509 are an autoencoder 540 and a deep neural network 545. The autoencoder 540 will be trained using unsupervised learning with the unlabeled samples 536 in a manner to be described more fully below. The deep neural network 545 will be trained using the smart annotation technique in a manner also to be described more fully below. Note that there is no requirement that the input samples 530, autoencoder 540, and deep neural network 545 reside in the same memory device or on the same computing resource as the instructions 527. As discussed above, the computing apparatus 503 may be implemented as a distributed computing system. Accordingly, the input samples 530, autoencoder 540, deep neural network 545, and instructions 527 may reside in different memory devices and/or in different computing resources in some embodiments.

Turning now specifically to the autoencoder 540, an autoencoder is a specific type of neural network that can be used to learn a compressed representation of raw data. An autoencoder includes an “encoder” 541 and a “decoder” 542. The encoder 541 compresses the input and the decoder 542 attempts to recreate the input from the compressed version provided by the encoder. This is sometimes referred to as “feature extraction”. The compressed input produced by the encoder 541 is sometimes called “the code” of the autoencoder 540. After training, the encoder 541 is saved and the decoder 542 may be discarded.

FIG. 6A-FIG. 6B depict one particular autoencoder 600 suitable for practicing the technique disclosed herein. Note that there are many kinds of autoencoders and many ways to implement each of the encoder kinds that are well known to the art. For the sake of clarity and so as not to obscure that which is claimed below, a full discussion of all these kinds and implementations is omitted. However, those in the art having the benefit of this disclosure may appreciate other kinds of autoencoders and other implementations that may also be effective in implementing the autoencoder 540.

The autoencoder 600 includes an encoder 603 and a decoder 606. The encoder 603 comprises a plurality of modules 609a-609k and the decoder 606 comprises a plurality of modules 612a-612k. In the context of this disclosure, a “module” is an identifiable piece of software that performs a particular function when executed. Each of the modules 609a-609k and 612a-612k is identified using a nomenclature known to the art and performs a function known to the art. One skilled in the art will therefore be able to readily implement the autoencoder 600 from the disclosure herein. As noted above, both the encoder 603 and the decoder 606 are used in training the autoencoder 600 through unsupervised training after which the encoder 603 may be discarded.

The term “module” is used herein in its accustomed meaning to those in the art. A module may be, for example, an identifiable piece of executable code residing in memory that, when executed, performs a specific functionality. Depending on the embodiment (or the context in which that term is used), a module may also, or alternatively, be an identifiable piece of hardware and/or identifiable combination of software and hardware that perform a specific functionality. The software and/or hardware of the module may be dedicated to a single use or may be utilized for multiple uses. Other established meanings may be realized by those in the art having the benefit of this disclosure.

Returning now to FIG. 5, in addition to the autoencoder 540, the computing apparatus 503 includes a deep neural network 545 as was first mentioned above. The deep neural network 545 may be any kind of deep neural network known to the art trained through supervised learning. Accordingly, the deep neural network 545 is a different kind of neural network than is the autoencoder 540. In the illustrated embodiment, the deep neural network 545 is a convolutional neural network although alternative embodiments may employ other kinds of deep neural networks. One example convolutional neural network that can be used is ResNet. For example, alternative embodiments may employ, without limitation, a recurrent neural network or some other deep neural network trained through supervised training.

FIG. 6C depicts one particular deep neural network 650 suitable for practicing the technique disclosed herein. Note that there are many kinds of deep neural network and many ways to implement each of the deep neural network kinds that are well known to the art. For the sake of clarity and so as not to obscure that which is claimed below, a full discussion of all these kinds and implementations is omitted. However, those in the art having the benefit of this disclosure may appreciate other kinds of deep neural network and other implementations that may also be effective in implementing the deep neural network.

The deep neural network 650 is, in this particular embodiment, a convolutional neural network (“CNN”). Note that Resnet is one particular type of CNN. The deep neural network 650 comprises a plurality of modules 660a-660m. Again, in the context of this disclosure, a “module” is an identifiable piece of software that performs a particular function when executed. Each of the modules 660a-660m is identified using a nomenclature known to the art and performs a function known to the art. One skilled in the art will therefore be able to readily implement the deep neural network 650 from the disclosure herein.

Returning again to FIG. 5, a part of the supervised training for a deep neural network such as the deep neural network 545 is “feature extraction”. More particularly, feature extraction typically involves processes such as convolution and pooling, for example. In accordance with the presently disclosed technique, in training the deep neural network 545 through supervised training, the deep neural network 545 uses the autoencoder 540 trained through unsupervised learning for the feature extraction. The embodiments illustrated herein therefore employ a convolutional neural network using the decoder 606 of the autoencoder 600 for feature extraction during unsupervised training.

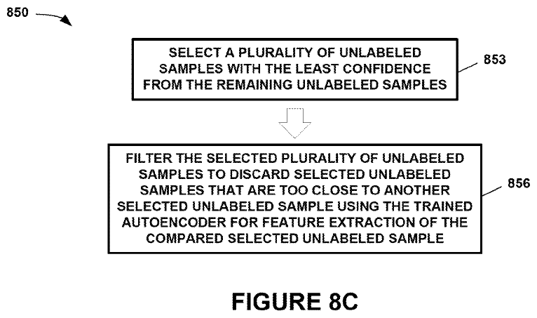

FIG. 7 illustrates a method 700 as may be practiced in accordance with one or more embodiments of the subject matter claimed below. Generally, the autoencoder is first trained. Then, the method starts deep neural network training. After each iteration, the autoencoder is used to determine if the new sample is close to a sample previously picked. The intent is to pick samples with different categorization (normal, non-normal, halfway between normal and non-normal).

Referring now collectively to FIG. 5 and FIG. 7, the method 700 begins by training (at 710) an autoencoder 540 with a set of unlabeled input samples 536 through unsupervised learning, the unlabeled input samples 536 being recorded waveforms representing a physiological characteristic. The autoencoder 540 may be, for example, the autoencoder 600 shown in FIG. 6 although other embodiments may use other suitable autoencoders. Note that, as discussed above relative to FIG. 6, both the encoder 603 and the decoder 606 are used in training the autoencoder 600.

The unlabeled samples 536 used in training (at 710) the autoencoder 540 are, in the illustrated embodiments, individual “beats” such as the input samples 322 shown in FIG. 3 and discussed above. The input samples 536 used to train (at 710) the autoencoder 600 are therefore representative of individual heartbeats of an individual in this particular embodiment. The autoencoder 600 is trained to recognize whether individual input samples 322 are “normal” or “non-normal”. However, in alternative embodiments in which the input samples are representative of some other physiological characteristic, the autoencoder may be trained to categorize the input samples differently. Once the autoencoder 600 is trained, the encoder 603 may be discarded.

The method 700 then continues by training (at 720) the deep neural network 545 through supervised learning using the trained (at 710) autoencoder 540. The deep neural network 545 may be, for example, a convolutional neural network. In general, training the deep neural network 545 iteratively performs a process on a set of inputs that includes a feature extraction on the set of inputs and the classifies the inputs based on the extracted features. The neural network 545, in the method 700, uses the trained autoencoder 540 for the feature extraction.

More particularly, in accordance with the presently disclosed technique, the method 700 iteratively trains (at 740) the deep neural network with a plurality of successive subsets of manually labeled samples 533 drawn from the unlabeled samples 536 until convergence or until the unlabeled sample inputs 536 are exhausted. Each successive subset comprises a plurality of selected, distanced, unlabeled samples with the least confidence from the remaining unlabeled samples to which labels are propagated. Again, the distance determination includes using the autoencoder 540 for feature extraction.

FIG. 8A-FIG. 8C depict a method 800 in accordance with one or more particular embodiments that is partly computer-implemented. Referring now to FIG. 8A, the method 800 begins with training (at 810) an autoencoder with a plurality of unlabeled input samples through unsupervised learning. The unlabeled input samples are recorded waveforms representing a physiological characteristic of a human body. For example, the samples may be “beats”, or individual patient heartbeats, such as the input samples 322 shown in FIG. 3 and may be used to train, for a further example, the autoencoder 540 in FIG. 5. Once the autoencoder is trained (at 810), the method 800 continues by training (at 820) a deep neural network through supervised learning using the trained autoencoder. The deep neural network may be, for instance, the deep neural network 545 shown in FIG. 5.

The training (at 820) of the deep neural network first shown in FIG. 8A is shown in FIG. 8B. The training (at 820) may begin, in this particular embodiment, by manually labeling (at 830) a first predetermined number of randomly selected unlabeled samples from the plurality of unlabeled input samples to generate a first subset of labeled samples. Note that this act also creates a subset of unlabeled samples that is smaller than the initial set of unlabeled samples. Furthermore, as unlabeled samples are selected and labeled, they are then removed from the set of unlabeled samples such that the number of unlabeled samples is reduced.

Once the first subset of labeled samples is obtained (at 830), the training (at 820, FIG. 8A) continues by training (at 840) the deep neural network with the first subset of labeled samples. The training (at 840) may be supervised training. Next, manually labeling (at 850) a second predetermined number of selected, distanced, unlabeled samples generates a second subset of labeled samples. As shown in FIG. 8C, the manual labeling (at 850) includes selecting (at 853) a plurality of unlabeled samples with the least confidence from the remaining unlabeled samples. The selected plurality of unlabeled samples is then filtered (at 856) to discard selected unlabeled samples that are too close to another selected unlabeled sample using the trained autoencoder for feature extraction of the compared selected unlabeled sample. Note that, upon discard, the selected unlabeled samples may be returned to the subset of unlabeled samples.

The predetermined number of the second subset of labeled samples produced by the manual labeling (at 850) should exceed a threshold number. This threshold number may be achieved in a number of ways. For instance, the number of unlabeled samples initially selected for manual labeling (at 850) may be of some statistically ascertained number such that, even after unlabeled samples are discarded, the remaining labeled samples are sufficient in number to exceed the threshold. Or, if the discards take the number of labeled samples in the second set below the threshold, then additional unlabeled samples may be selected and processed. Or some combination of these approaches may be used. Still other approaches may become apparent to those skilled in the art having the benefit of this disclosure.

Returning to FIG. 8B, once the manual labeling (at 850) of the second set of labeled samples has been performed, labels are propagated (at 860) to the second predetermined number of selected, distanced, unlabeled samples from among the remaining unlabeled samples that are closest to the labeled samples. The training (at 820) as shown in FIG. 8B is iterated (at 870) until either convergence or the remaining unlabeled samples are exhausted. In this context, “convergence” is an absence of variation in result and may be objectively quantified. One implementation with an objective quantification will now be discussed.

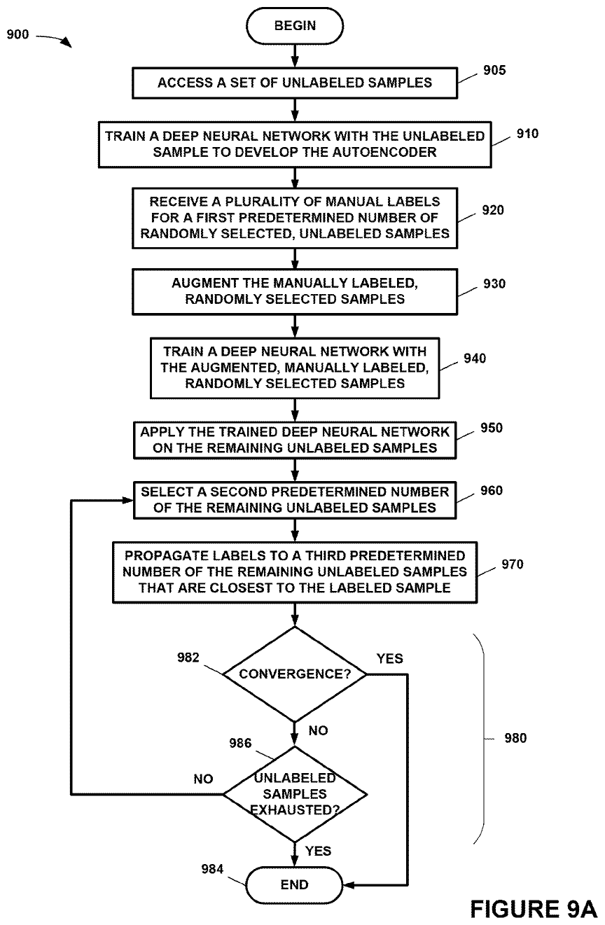

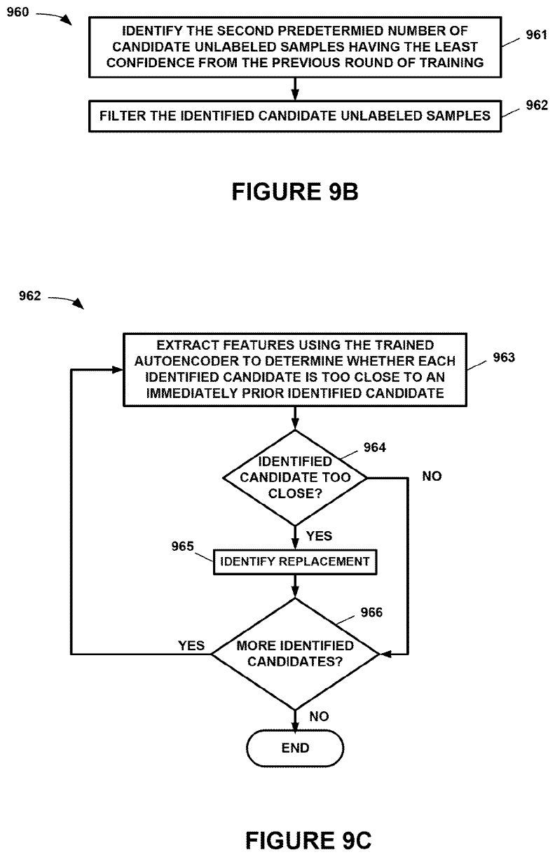

FIG. 9A-FIG. 9C illustrate a method 900 for use in annotating a plurality of recorded waveforms representing a physiological characteristic of a human body. As was discussed above with respect to the earlier disclosed embodiments, the physiological characteristic of the illustrated embodiments may be a “beat”, or an individual patient heartbeat previously acquired as discussed relative to FIG. 1 and FIG. 2. However, in other embodiments the physiological characteristic may be some other physiological characteristic, such as blood pressure, respiration, blood oxygenation, etc. Furthermore, the present embodiment presumes that the input samples were previously acquired and have been stored awaiting their use in the method 900. However, some embodiments may include data acquisition and processing to prepare and condition the input samples for annotation.

The method 900 is computer-implemented. For present purposes, the discussion will assume the method is being implemented on the computing apparatus 503 of FIG. 5. However, as noted above, the computer-implemented aspects of the subject matter claimed below are not limited to implementation on a computing apparatus such as the computing apparatus. Some embodiments may be implemented in a computing environment distributed across various computational and storage resources of a cloud accessed over the Internet from a workstation, for instance.

The method 900 is performed, in this particular embodiment, by the processor-based resource 506 through the execution of the instructions 527. The method 900 may be invoked by the user 500 through the user interface 512. More particularly, the user 500 may invoke the method 900 using a peripheral input device, such as the keyboard 518 or the mouse 521, to interact with a user interface, such as a graphical user interface (“GUI”), presented by the UI 524.

Referring now to FIG. 9A and FIG. 5, the method 900 begins by accessing (at 905) a set of unlabeled samples 536 of the recorded waveforms. The unlabeled input samples are recorded waveforms representing a physiological characteristic of a human body. For example, the samples may be “beats”, or individual patient heartbeats, such as the input samples 322 shown in FIG. 3. In the illustrated embodiment, the number of unlabeled samples may be, for instance, 500 samples.

The method 900 then trains (at 910) a deep neural network with the unlabeled samples 536 to develop the autoencoder 540. As the samples are unlabeled, this training (at 910) is unsupervised training. As discussed above, the autoencoder 540 includes the encoder 541 and the decoder 542. The encoder 541 may be used only in training (at 910) of the autoencoder 540 and may be discarded afterward.

The method 900 then receives (at 920) a plurality of manual labels for a first predetermined number of randomly selected, unlabeled samples 536. More particularly, the user 500 randomly selects a number N of samples from among the unlabeled samples 536 through the user interface 512 and manually labels them. In the illustrated embodiment, N=56, but may have other values. For example, in other embodiments N may be 40 or 80. The processor-based resource 506 receives the manual labels from the user 500 for the randomly selected, unlabeled samples 536 to create the labeled samples 533. Note that, as samples are selected and labeled, they are removed from the pool of unlabeled samples 536 to join the pool of labeled samples 533.

The manually labeled, randomly selected samples are then “augmented” (at 930). Augmentation is a process known to the art by which distortion or “noise” with relatively little variation is intentionally introduced to the samples to avoid a phenomenon known as “overfitting”. In this context, overfitting describes a condition in which the training so tailors the deep neural network to the samples on which it is trained that it impairs the deep neural network's ability to accurately classify other samples on which it has not been trained. This is an optional step and may be omitted in some embodiments.

Those in the art having the benefit of this disclosure will appreciate that augmenting the samples is but one way to condition the samples. There are other techniques known to the art by which the samples may be conditioned. Other embodiments may therefore also use other techniques instead of, or in addition to, augmentation to mitigate overfitting and address other issues that may be encountered from unconditioned samples.

The method 900 then trains (at 940) the deep neural network 545 with the augmented, manually labeled, randomly selected samples 533. As mentioned above, the deep neural network 545 is a convolutional neural network although alternative embodiments may employ other kinds of deep neural networks. The training is an example of supervised training since the samples being used are labeled.

The method 900 then applies (at 950) the trained deep neural network 545 to the remaining unlabeled samples 536. This application results in additional unsupervised training for the deep neural network 545 since the unlabeled samples 536 are unlabeled. Thus, the presently disclosed technique may be referred to as a hybrid supervised-unsupervised learning technique. Likewise, the deep neural network 545, at the conclusion of training, may be referred to as hybrid supervised-unsupervised trained.

Next, the method 900 continues by selecting (at 960) a second predetermined number of selections of the remaining unlabeled samples 536. In this embodiment, the second predetermined number is equal to the first predetermined number (at 920), but other embodiments may use a second predetermined number that differs from the first predetermined number. Although some aspects of the selection (at 960) may be performed manually in some embodiments, the selecting (at 960) is performed in an automated fashion in this embodiment. The selecting (at 960) is performed by the processor-based resource 506 executing the instructions 527.

As shown in FIG. 9B, the selection (at 960) begins by identifying (at 961) the second predetermined number of candidate unlabeled samples 536 having the least confidence from the previous round of training. “Confidence” in this context means confidence that the outcome of the deep neural network is correct. “Least confidence”, then, describes the unlabeled samples 536 in which the previous application of the neural network (at 950) yielded the “least confidence” of having achieved a correct output. That is, the least confidence that the classification of the given unlabeled samples 536 was correct.

The “least confidence” unlabeled samples 536 that have been identified (at 961) are then filtered (at 962). As shown in FIG. 9C, the filtering may include using (at 963) the trained autoencoder for feature extraction to determine whether each identified candidate is too close to an immediately prior identified candidate. In this particular embodiment, “too close” is measured by the trained autoencoder 540 for feature calculation and is set to be 5% of maximum magnitude and distance on a vector. However, other embodiments may use other measures of “too close”, use some filtering technique other than that shown in FIG. 9C, or even omit this filtering (at 963)

If (at 964) an identified candidate is too close to the immediately prior identified candidate, the identified candidate may be discarded. A replacement candidate for the discarded candidate may then be identified (at 965). This process of identifying (at 963), discarding (at 964), and replacing (at 965) may be iterated (at 966) until the second predetermined number of unlabeled samples has been identified and filtered.

Note that alternative embodiments may select (at 960) the second predetermined number of selections of the remaining unlabeled samples 536 differently than has been described above relative to FIG. 9B and FIG. 9C. The point of the step is to obtain the second predetermined number of unlabeled samples 536. Thus, the selection (at 960) process need not necessarily filter, discard, and identify replacements in all embodiments. For example, some embodiments might identify some third predetermined number of candidates that is greater than the second number and then discard lesser desired candidates until the second predetermined number of candidates is obtained. Those skilled in the art having the benefit of this disclosure may appreciate still other suitable variations by which the selection (at 960) may be performed.

Returning to FIG. 9A, after selecting (at 960) a second predetermined number of selections of the remaining unlabeled samples 536, the method 900 than propagates (at 970) labels to a third predetermined number of the remaining unlabeled samples that are closest to the labeled samples and adds these labeled (at 970) samples to the training set of labeled samples 533.

The method 900 then iterates (at 980) until either convergence or the remaining unlabeled samples are exhausted. More particularly, the method 900 first checks (at 982) whether convergence has been reached. In the illustrated embodiment, convergence is reached when accuracy changes less than 0.25% in five iterations. If convergence has been reached, the method 900 ends (at 984).

If there is no convergence (at 982), the method 900 checks (at 986) to see if the unlabeled samples 536 have been exhausted. Recall that each iteration removes samples from the set of unlabeled samples 536 by labeling them and, so, the set of unlabeled samples 536 may be exhausted in some embodiments by a sufficient number of iterations. If the unlabeled samples 536 are exhausted (at 986), the method 900 ends (at 984). If there are additional unlabeled samples 536 remaining (at 986), execution flow returns to the selection (at 960) of unlabeled samples 536.

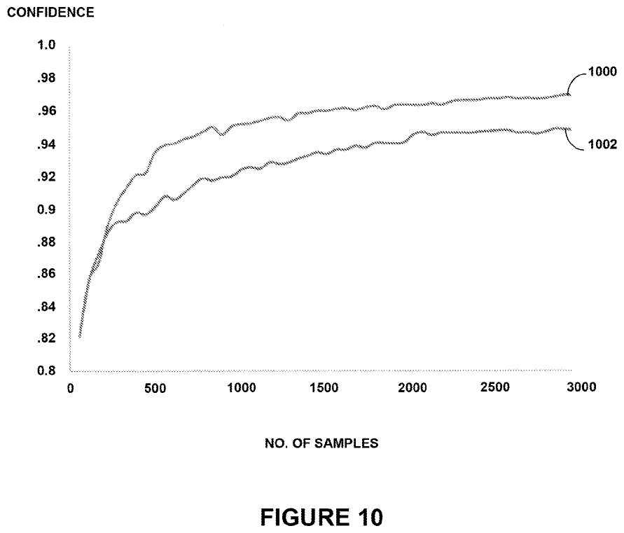

The efficacy of the technique disclosed herein is illustrated in FIG. 10. FIG. 10 illustrates a graphical representation of the classification accuracy versus the number of samples as described above. The presently disclosed technique is represented by the curve 1000 whereas a conventional technique using a random selection of input samples is represented by the curve 1002. As shown in FIG. 10, the presently disclosed technique achieves a higher level of confidence at the same or lower number of samples. Furthermore, as the number as samples increases, the greater the benefit of the disclosed technique. Thus, a trained deep neural network for use in classifying unlabeled input samples that are recorded waveforms representing a physiological characteristic of a human body can be developed more quickly and more accurately.

A deep neural network trained in the manner described herein, such as the deep neural network 545 shown in FIG. 5, may then be used in a clinical setting, such as the clinical setting shown in FIG. 1, to treat and/or diagnose a patient's condition. As noted above, the deep neural network may reside on a workstation or in a cloud and accessed by a user locally or remotely. Acquired samples representing a physiological characteristic of a human body, such as the beats 322 shown in FIG. 3, may then be processed by the deep neural network to classify the acquired samples. The process may be automated in the sense that the process is computer-implemented and performed without human interaction or intervention. The deep neural network trained as described herein can perform the automatic classification more consistently, more accurately, and more economically than current neural networks used for this purpose.

The foregoing outlines the features of several embodiments so that those of ordinary skill in the art may better understand various aspects of the present disclosure. Those of ordinary skill in the art should appreciate that they may readily use the present disclosure as a basis for designing or modifying other processes and structures for carrying out the same purposes and/or achieving the same advantages of various embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

It will be appreciated that layers, features, elements, etc., depicted herein are illustrated with particular dimensions relative to one another, such as structural dimensions or orientations, for example, for purposes of simplicity and ease of understanding and that actual dimensions of the same differ substantially from that illustrated herein, in some embodiments. Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second.” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

This concludes the detailed description. The particular examples disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular examples disclosed above may be altered or modified and all such variations are considered within the scope and spirit of the invention. Accordingly, the protection sought herein is as set forth in the claims below.

What is claimed is:

1. A method comprising:
training an autoencoder with a set of unlabeled input samples through unsupervised learning, the unlabeled input samples being recorded waveforms representing a physiological characteristic of a human body; and
training a deep neural network through supervised learning using the trained autoencoder, including:
training the deep neural network with a first subset of manually labeled samples selected from the set of unlabeled samples; and
iteratively training the deep neural network with a plurality of successive subsets of manually labeled samples drawn from the unlabeled samples until convergence or until the unlabeled sample inputs are exhausted, each successive subset comprising a plurality of selected, distanced unlabeled samples with the least confidence from the remaining unlabeled samples to which labels are propagated, the distance determination including using the autoencoder for feature extraction.

2. The method of claim 1, further comprising conditioning the first subset of labeled samples prior to training the deep neural network with the first subset of labeled samples to avoid overfitting.

3. The method of claim 1, wherein conditioning the first subset of labeled samples includes augmenting the first set of labeled samples.

4. The method of claim 1, wherein training the deep neural network with the first subset of manually labeled samples selected from the set of unlabeled samples includes:
receiving a plurality of manual labels for a first predetermined number of randomly selected, unlabeled samples; and
training a deep neural network with the manually labeled, randomly selected samples.

5. The method of claim 4, wherein training the deep neural network with the first subset of manually labeled samples selected from the set of unlabeled samples further includes augmenting the manually labeled, randomly selected samples.

6. The method of claim 1, wherein iteratively training the deep neural network with a plurality of successive subsets of manually labeled samples includes:
receiving a second predetermined number of selections of the remaining unlabeled samples; and
propagating labels to a third predetermined number of the remaining unlabeled samples that were closest to the labeled samples.

7. The method of claim 6, wherein the first predetermined number equals the second predetermined number.

8. The method of 6, wherein receiving the second predetermined number of selections includes:
identifying the second predetermined number of candidate unlabeled samples having the least confidence; and
filtering the identified candidate unlabeled samples to impose a distance between the candidate unlabeled samples.

9. The method of claim 8, wherein filtering the identified candidate unlabeled samples includes:
using the trained autoencoder for feature extraction to determine whether each identified candidate is too close to an immediately prior identified candidate;
if an identified candidate is too close to the immediately prior identified candidate, discarding the identified candidate;
identifying a replacement candidate for the discarded candidate; and
iterating the identifying and filtering until the second predetermined number of unlabeled samples has been identified and filtered;

10. The method of claim 8, wherein the identified candidate is too close in the sense that the identified candidate is <5% of maximum magnitude and distance on a vector.

11. The method of claim 1, wherein convergence is reached when accuracy changes less than 0.25% in five iterations.

12. A computing apparatus, comprising:
a processor-based resource; and
a memory electronically communicating with the processor-based resource and encoded with instructions that, when executed by the processor-based resource, perform the method of any of claims 1 to 11.

13. A non-transitory, computer-readable memory encoded with instructions that, when executed by the processor-based resource, perform the method of any of claims 1 to 11.

14. A method, comprising:
training an autoencoder with a plurality of unlabeled input samples through unsupervised learning, the unlabeled input samples being recorded waveforms representing a physiological characteristic of a human body; and
training a deep neural network through supervised learning using the trained autoencoder, including:
manually labeling a first predetermined number of randomly selected unlabeled samples from the plurality of unlabeled input samples to generate a first subset of labeled samples;
training the deep neural network with the first subset of labeled samples;
manually labeling a second predetermined number of selected, distanced, unlabeled samples to generate a second subset of labeled samples, including:
selecting a plurality of unlabeled samples with the least confidence from the remaining unlabeled samples; and
filtering the selected plurality of unlabeled samples to discard selected unlabeled samples that are too close to another selected unlabeled sample using the trained autoencoder for feature extraction of the compared selected unlabeled sample;
propagating labels to the second predetermined number of selected, distanced, unlabeled samples from among the remaining unlabeled samples that are closest to the labeled samples; and
iterating until either convergence or the remaining unlabeled samples are exhausted.

15. The method of claim 14, further comprising augmenting the first subset of labeled samples prior to training the deep neural network with the first subset of labeled samples to avoid overfitting.

16. The method of claim 14, wherein the first predetermined number equals the second predetermined number.

17. The method of claim 14, wherein the identified candidate is too close in the sense that the identified candidate is <5% of maximum magnitude and distance on a vector.

18. The method of claim 14, wherein convergence is reached when accuracy changes less than 0.25% in five iterations.

19. A method for use in annotating a plurality of recorded waveforms representing a physiological characteristic of a human body, the method comprising:
providing a set of unlabeled samples of the recorded waveforms;
training a deep neural network with the unlabeled samples to develop an autoencoder;
receiving a plurality of manual labels for a first predetermined number of randomly selected, unlabeled samples;
augmenting the manually labeled, randomly selected samples;
training a deep neural network with the augmented, manually labeled, randomly selected samples;
applying the trained deep neural network to the remaining unlabeled samples;
receiving a second predetermined number of selections of the remaining unlabeled samples, the selection comprising:
identifying the second predetermined number of candidate unlabeled samples having the least confidence;
filtering the identified candidate unlabeled samples by:
using the trained autoencoder for feature extraction to determine whether each identified candidate is too close to an immediately prior identified candidate;
if an identified candidate is too close to the immediately prior identified candidate, discarding the identified candidate;
identifying a replacement candidate for the discarded candidate; and
iterating the identifying and filtering until the second predetermined number of unlabeled samples has been identified and filtered;
propagating labels to a third predetermined number of the remaining unlabeled samples that were closest to the labeled samples; and
iterating until either convergence or the remaining unlabeled samples are exhausted.

20. The method of claim 19, wherein the first predetermined number equals the second predetermined number.

21. The method of claim 19, wherein the identified candidate is too close in the sense that the identified candidate is <5% of maximum magnitude and distance on a vector.

22. The method of claim 19, wherein convergence is reached when accuracy changes less than 0.25% in five iterations.

23. A computing apparatus, comprising:
a processor-based resource; and
a memory electronically communicating with the processor-based resource and encoded with instructions that, when executed by the processor-based resource, perform the method of any of claims 19 to 22.

24. A non-transitory, computer-readable memory encoded with instructions that, when executed by the processor-based resource, perform the method of any of claims 19 to 22.
